(19) United States
(12) Patent Application Publication
(10) Pub. No.: US 2007/0211791 A1
(43) Pub. Date: Sep. 13, 2007

(54) Coherent processing using composite codes

(76) Inventors: Suman Ganguly, Falls Church, VA (US); Aleksandar Jovancevic, Centreville, VA (US)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/221,358

(22) Filed: Sep. 7, 2005

(51) Int. Cl. H04B 1/00

(52) U.S. Cl. 375/148; 375/150

(57) ABSTRACT

A coherent processor having replica generator, a plurality of correlators, a combiner and a tracking loop. The replica generator generates a composite-reference signal having a replica of the plurality of the IM code, M code, P(Y) code or C/A code. The plurality of correlators correlates a received signal from a particular global positioning satellite, with the plurality of the IM code, M code, P(Y) code or C/A code, respectively, of the composite-reference signal, thereby generating a plurality of despread signals. The combiner combines the plurality of despread signals from the plurality of correlators. The tracking loop maintaines lock between the received signal and the composite-reference signal.

### BACKGROUND OF THE INVENTION

The present invention relates to global positioning systems, and more particularly to coherent processing using composite code received from global positioning satellites.

### DESCRIPTION OF THE RELEVANT ART

GPS and other navigational systems utilize a variety of codes overlaid in certain frequency bands. In the current art, these codes are treated separately. Multiple correlators for CA code, P code and M code are used for treating them individually.

### SUMMARY OF THE INVENTION

A general object of the invention is improved coherent processing of signals from global positioning satellites.

Another object of the invention is to utilize coherent code correlation with composite codes.

An additional object of the invention is to improved the signal-to-noise ratio (SNR) and to reduce the number of correlators.

According to the present invention, as embodied and broadly described herein, a coherent processor for use with a plurality of global positioning satellites, is provided. Each global positioning satellite transmits on a plurality of frequencies, a plurality of signals modulated by a plurality of spread-spectrum codes, respectively. The coherent processor includes a replica generator, a correlator and a tracking loop. The replica generator generates a composite-reference signal having a replica of the plurality of spread-spectrum codes. The correlator correlates a received signal from a particular global positioning satellite, with the composite-reference signal. The tracking loop maintains lock between the received signal and the composite-reference signal. Preferably, the replica generator generatesg the composite-reference signal with the plurality of spread-spectrum codes including the IM code, M code, P(Y) code or C/A code.

An alternative embodiment of the invention provides a coherent processor having replica generator, a plurality of correlators, a combiner and a tracking loop. The replica generator generates a composite-reference signal having a replica of the plurality of spread-spectrum codes. The plurality of correlators correlates a received signal from a particular global positioning satellite, with the plurality of spread-spectrum codes, respectively, of the composite-reference signal, thereby generating a plurality of despread signals. The combiner combines the plurality of despread signals from the plurality of correlators. The tracking loop maintaines lock between the received signal and the composite-reference signal.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 shows GPS signal modernization program;

FIG. 2 illustrates Galileo, GLONASS and GPS frequency bands;

FIG. 3 depicts Galileo frequency spectrum;

FIG. 4 is YMCA++ receiver block diagram;

FIG. 5 illustrates C/A, P(Y), M and composite signal autocorrelation function;

FIG. 6 is a GPS channel block diagram;

FIG. 7 is a block diagram of conventional, prior art, tracking;

FIG. 8 is a block diagram of coherent processing using composite codes; and

FIG. 9 is a block diagram of coherent processing using separate codes.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

GPS and other navigational systems utilize a variety of codes overlaid in certain frequency bands. In the current art, these codes are treated separately. Multiple correlators for CA code, P code and M code are used for treating them individually.

Code Structures:

1. C/A Code

The C/A code is a periodic signal with one millisecond period. The C/A code does not require an accurate clock to acquire and track a satellite. However, without NAV data bit synchronization, the C/A code cannot be used for pseudo-range measurement. The chipping rate of the C/A code is 1.023 Mchips/sec.

2. P(Y) Code

The P(Y) code is considered to be a non-periodic code, because the period is forced to be one week. The P(Y) code requires accurate clock information to limit the search space for signal acquisition. The P(Y) code does not require NAV data bit synchronization to form pseudo-range measurements. The chipping rate of the P(Y) code is 10.23 Mchips/sec, which offers ten times better ranging capability than the C/A code. The P(Y) code is encrypted and only authorized, e.g. military, users have access to the P(Y) code.

3. L2C Code

The L2C code is a new civilian code. The L2C code will be transmitted on the L2 carrier frequency. The L2C code includes two signals, L2CM and L2CL. Each of 511.5 Kchips/sec is inter-leaned, with a resultant chipping rate of 1.023 Mchips/sec. The L2CM period is 20 milliseconds, and the L2CL period is 1.5 seconds. With the L2CM signal, acquisition can be performed without accurate clock information. The L2C Code also does not need NAV data bit synchronization in order to perform pseudo-range measurement.

4. L5 Code

The L5 code is a new civilian code. The L5 code will be transmitted on the L5 carrier frequency. The L5 code includes two signals, an in-phase signal (I₅) and a quadrature-phase signal (Q₅). The in-phase signal (I₅) and the quadrature-phase signal (Q₅) are 10.23 Mchips/sec and are transmitted in quadrature at the same data rate and carrier frequency. Pseudo-random sequences for the in-phase signal (I₅) and the quadrature-phase signal (Q₅) have a period of one millisecond. An additional code, the Neuman-Hoffman code, is superimposed on top of each of the in-phase signal (I₅) and the quadrature-phase signal (Q₅), so that the resulting period is ten milliseconds for the L5 code and 20 milliseconds for the quadrature-phase signal Q₅. Therefore, the acquisition can be performed without accurate clock information and the pseudo-range measurement can be performed without NAV data bit synchronization. Because of the higher chipping rate of the L5 code, the L5 code has ten times better ranging capability than the C/A code.

5. M-Code

The M code is a new military code. The M code will be transmitted on both L1 and L2 carrier frequencies. The M code has a pseudo-random sequence with chipping rate of 5.115 Mchips/sec. The M code, however, is modulated with a 10 MHz square-wave sub-carrier so that the effective chipping rate is 20.46 mchips/sec. The M code is considered to be a non-periodic code, because the period is forced to be one week. Therefore, the M code requires accurate clock information to limit the search space for signal acquisition. The M code does not need NAV data bit synchronization to form pseudo-range measurement. Because of its high effective chipping rate it has the best ranging resolution. Only authorized, e.g. military, users will have access to the M code.

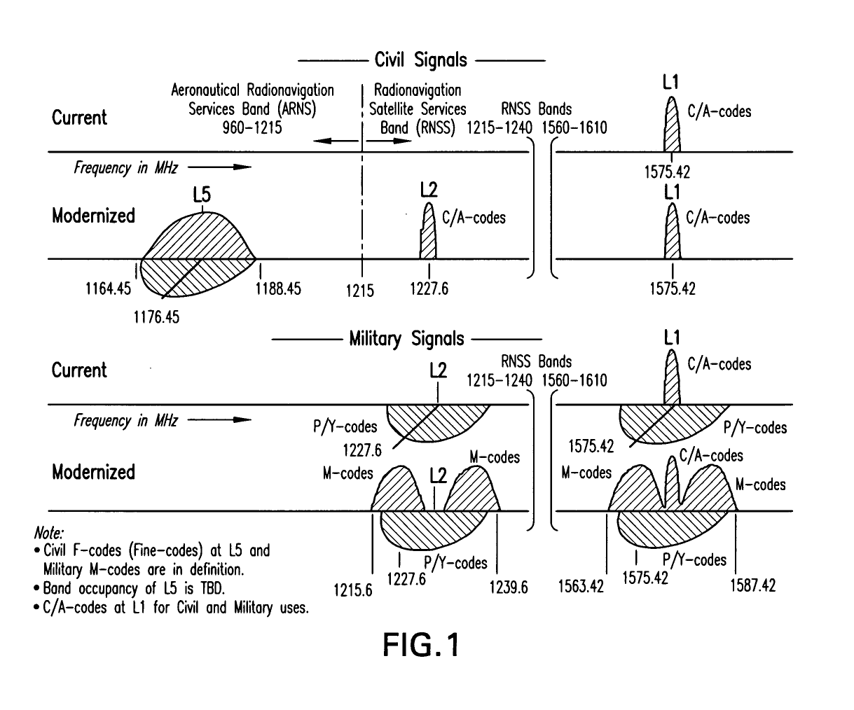

The current and proposed frequency and code allocations (GPS only) have been described by many authors and is reproduced in FIG. 1.

6. Galileo

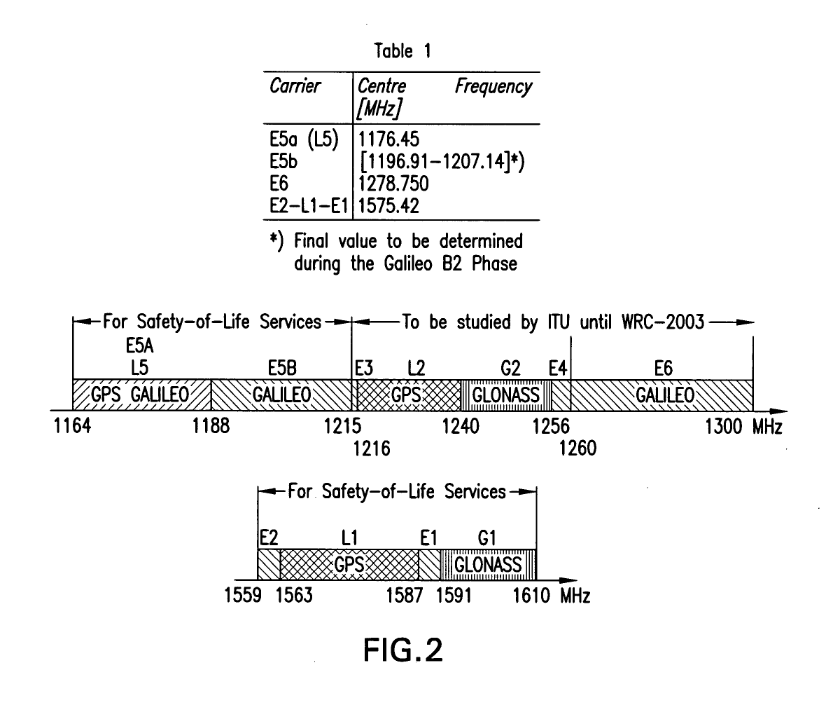

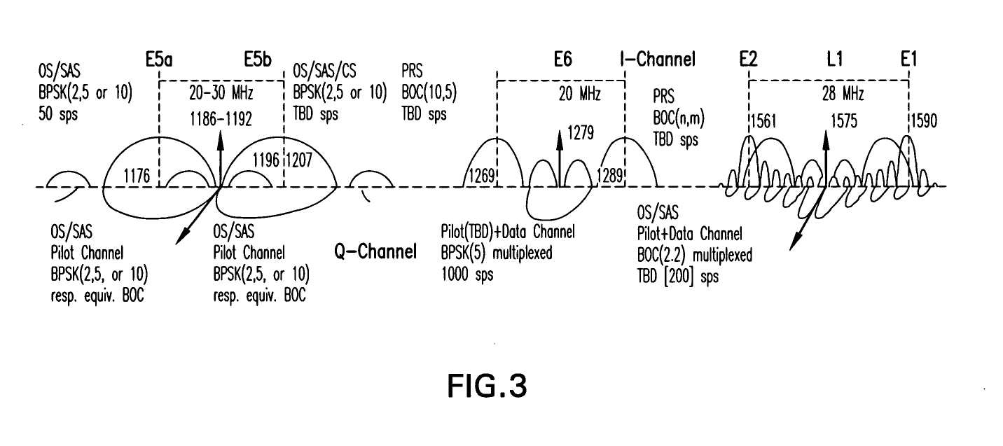

Galileo constellation will have a variety of codes and frequency allocations. Current information is summarized below. Center frequencies for Galileo are presented in Table 1 and FIG. 2. The E5a carrier also is named L5. The overall Galileo signal structure is shown in FIG. 3. A time division-multiplexing scheme in E6 and E2-L1-E1 is assumed for the B and C channels.

It is apparent that some of the Galileo codes are superimpose on the GPS bands. Besides the codes, CA, P, M, L2C, for the GPS constellation, various other codes, similar to standard GPS codes, such as those required for Wide Area Augmentation System (WAAS), SBAS and regional systems may be superposed on the same channel.

Several schemes for implementation of such apparatuses for different purposes.

Structure of composite code correlators.

Apparatus for navigation using GPS and/or Galileo constellation, where any combination of codes can be used as desired.

The coherent correlation scheme should be extended to any future system using similar CDMA codes.

All of these codes are overlaid on one another and share the similar bends in frequency spectrum L1, L2, L5 bands, etc. All the receivers receive the incoming signals within a certain spectral domain and then perform correlation individually for each of these codes.

The innovation described in this disclosure utilizes the composite code within a specified frequency band and perform the correlation of the composite signal. This disclosure describes schemes to utilize coherent processing using composite codes. This allows:

Superior SNR and performance using composite codes.

Reduction in hardware.

Selective utilization of any combination of codes.

Vertical upgrade for future signals and codes.

The implementation of the composite code correlation has several issues associated with their applications and performance. Several different implementation schemes are disclosed. Innovation in using the composite code structure within a certain spectral band, so long as the codes are generated and propagated in a coherent fashion. This claim is being implemented using GPS constellation. It can be used for any other constellation.

We claim to these innovations and describe the apparatus using coherent processing of GPS signals. The scheme can be used for Galileo and other signals.

Coherent Processing and Advanced YMCA++ Receiver Concept

YMCA++ receiver is capable of receiving all existing and planned GPS signals (C/A, P(Y), M, L2C, L5), planned Galileo signals and other existing and future signals (WAAS, LAAS, SBAS etc.). The capability to receive and process all these signals results in a superior navigational accuracy, anti jamming and multipath immunity compared to GPS or Galileo systems individually. The combination of multiple navigational systems provides diversity in which the receiver can select which signals to use based on signal strength, jamming conditions, multipath environment etc. In addition to this, ultratightly coupling with INS will provide additional anti jamming performance and high-dynamics performance.

Since GPS and Galileo signals are broadcast from separate satellites, they cannot be processed coherently. Generally, each signal will have its own dedicated channel to process it. Also, each satellite transmit signal at multiple frequencies. These signals are generally processed separately because even though they are transmitted simultaneously, they experience different propagation channels before reaching the receiver and become incoherent. However, the signals transmitted at the same frequency can be processed separately or coherently.

Conventional receiver has separate processing paths for each of the transmitted codes (C/A, P(Y) and M) with each having its own tracking logic. Then, they are added coherently or incoherently to increase the SNR. Having individual tracking logic for each signal even though they are transmitted synchronously adds additional computational burden.

Typical number of correlators for conventional receiver is 3 to 5. More correlators are used only for multipath rejection algorithms where correlation function with high enough resolution is required. Advanced YMCA++ receiver uses FFT block processing, which inherently provides large number of correlators with the time resolution equal to the sampling rate of the incoming signal.

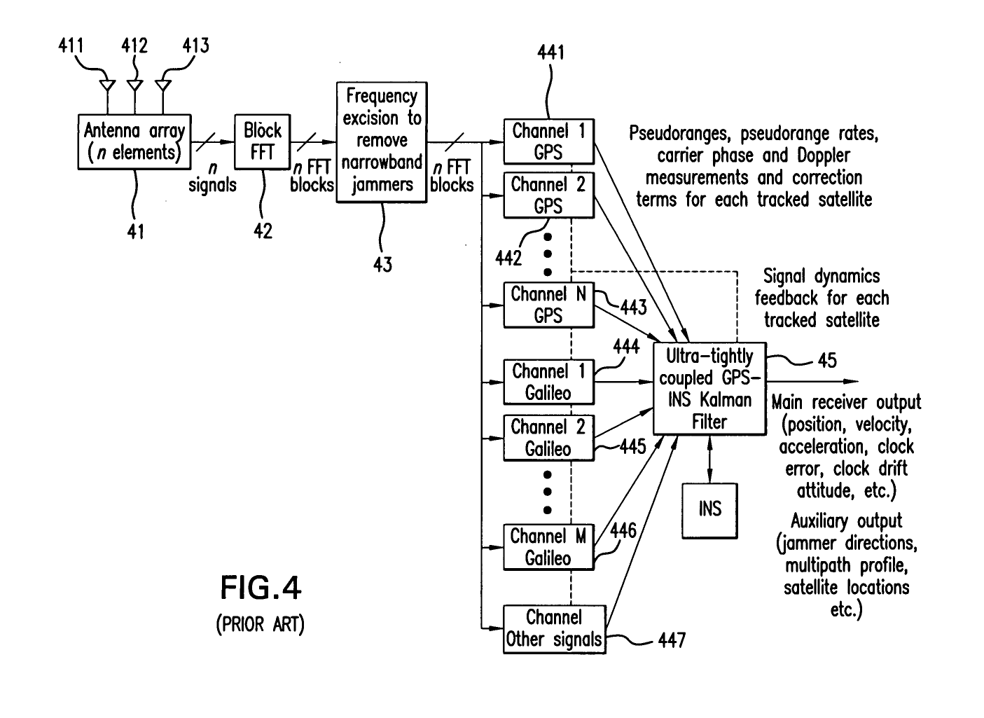

Block diagram of an advanced YMCA++ receiver is depicted in FIG. 4. A receiver is provided comprising an antenna array 41, a plurality of channel processors 441, 442, 443, 444, 445, 446, 447, and a navigation filter 45. The antenna array 41, has a plurality of elements 411, 412, 413. The plurality of elements 411, 412, 413 outputs a plurality of signals, respectively.

Each channel processor 441, 442, 443, 444, 445, 446, 447 has a block processor 42, coupled to the antenna array 41, for fast-Fourier-transform (FFT) correlating the plurality of signals, to a plurality of decorrelated signals, respectively. In response to signal dynamics for each respective tracked satellite, the plurality of channel processors 441, 442, 443, 444, 445, 446, 447 processes at a plurality of frequencies the plurality of decorrelated signals from the plurality of FFT blocks, to determine a multiplicity of signal estimates pseudo-range estimates, pseudo-range rate estimates, carrier phase estimates, Doppler estimates and correction terms for each respective tracked satellite.

The navigation filter 45 is coupled to the plurality of channel processors 441, 442, 443, 444, 445, 446, 447. In response to the multiplicity of estimates pseudo-range estimates, pseudo-range rate estimates, carrier phase estimates, Doppler estimates and correction terms for each respective tracked satellite, the navigation filter generates signal dynamics for each respective tracked satellite, with the signal dynamics including position, velocity, acceleration, clock error, clock drift, and attitude.

The receiver can have the plurality of channel processors 441, 442, 443, 444, 445, 446, 447 for processing the plurality of decorrelated signals to determine the multiplicity of signal estimates, with the multiplicity of signal estimates including at least two of pseudo-range estimates, pseudo-range rate estimates, carrier phase estimates, Doppler estimates and correction terms, for each respective tracked satellite. In response to the respective at least two of pseudo-range estimates, pseudo-range rate estimates, carrier phase estimates, Doppler estimates and correction terms, for each respective tracked satellite, the navigation filter generates signal dynamics for each respective tracked satellite.

The receiver can have the navigation filter 45, responsive to the respective multiplicity of signal estimates for each respective tracked satellite, for generating signal dynamics for each respective tracked satellite, with the signal dynamics including at least two of position, velocity, acceleration, clock error, clock drift, and attitude.

The receiver can have the plurality of channel processors 441, 442, 443, 444, 445, 446, 447 processing the plurality of decorrelated signals to determine the multiplicity of signal estimates, with the multiplicity of signal estimates including pseudo-range estimates, pseudo-range rate estimates, carrier phase estimates, Doppler estimates and correction terms, for each respective tracked satellite, The navigation filter, responsive to the respective pseudo-range estimates, pseudo-range rate estimates, carrier phase estimates, Doppler estimates and correction terms, for each respective tracked satellite, for generating signal dynamics for each respective tracked satellite, with the signal dynamics including position, velocity, acceleration, clock error, clock drift, and attitude.

The receiver further may include a respective interference filter 43, coupled to each respective block processor 42, for removing narrowband jammers from the plurality of decorrelated signals. The receiver may have each respective block processor 42 further including a parallel correlator structure, for improving signal fidelity through high-resolution correlator function, to drive code and carrier tracking errors through correlation pattern matching. The receiver may have each respective block processor 42 further including multipath mitigation algorithms.

The receiver may have each respective block processor 42 further including extended number of correlators for high-dynamics applications when tracking loop bandwidth must be kept low to prevent excessive noise, from corrupting the signal.

The receiver may have each respective block processor 42 further including anti jamming techniques using spectral excision of narrowband jammers and spatial nulling wideband jammers.

The receiver may have each respective block processor 42 further including anti jamming techniques using spectral excision of narrowband jammers. The receiver may have each respective block processor 42 further including anti jamming techniques using spatial nulling wideband jammers. The receiver may have each respective block processor 42 further including a combiner for combining, in frequency domain, the plurality of signals from the plurality of antenna elements using wideband beam forming for desired satellites and spatial nulling for jammer suppression. The receiver may have each channel processor in the plurality of channel processors for correcting the pseudo-range estimate and the pseudo-rate estimate for ionospheric and tropospheric delay and satellite clock bias and drift.

The receiver may have each channel processor 441, 442, 443, 444, 445, 446, 447 in the plurality of channel processors processing in parallel with a plurality of correlation functions, the respective plurality of signals from a respective satellite

The receiver utilizes n-element antenna array 41, where n is a number of elements, in the plurality of elements 411, 412, 413, which provides spatial diversity. FFT block processing with a block processor 42 is performed on all antenna signals separately. Block processing using FFT provides several benefits. First, it allows massively parallel correlator structure to be implemented very efficiently. Large number of correlators is necessary to improve signal fidelity through extremely high-resolution correlation function, which is used to derive code and carrier tracking errors through correlation pattern matching. Second, this technique also enables powerful multipath mitigation algorithms to be used. Third, extended number of correlators is extremely important in high-dynamics applications when tracking loop bandwidth must be kept low to prevent too much noise from corrupting the signal, which in conventional 3 and 5 correlator-tracking schemes may result in a loss of lock. Finally, FFT block processing can conveniently be combined with anti jamming techniques both through spectral excision, for narrowband jammers, and in spatial nulling for wideband jammers. In the latter technique, the signals from multiple antenna elements are combined in frequency domain using wideband beamforming, for desired satellite, and spatial nulling, for jamming suppression. In addition, jammer locations are detected using STAP techniques.

Each channel processor 441, 442, 443, 444, 445, 446, 447 processes a single satellite signal. Beamforming is performed independently for each satellite, while the list of jammers is common for all channels. However, processing jammers for each satellite individually provides more optimal control for combining the signals from multiple antennas. Each channel processes multiple frequencies (L1, L2, L5) and provides pseudorange and pseudorange-rate estimates that are corrected for ionospheric and tropospheric delay and satellite clock bias and drift. These estimates are fed to the Kalman Filter. The Kalman Filter also gets the INS measurements and provides output of the combined system, which includes position, velocity, and acceleration of the receiver and receiver clock bias and drift. Additional outputs can also be provided such as jamming directions, multipath profile etc. In an ultratightly coupled configuration, Kalman filter also generates the feedback signals for tracking of the satellites.

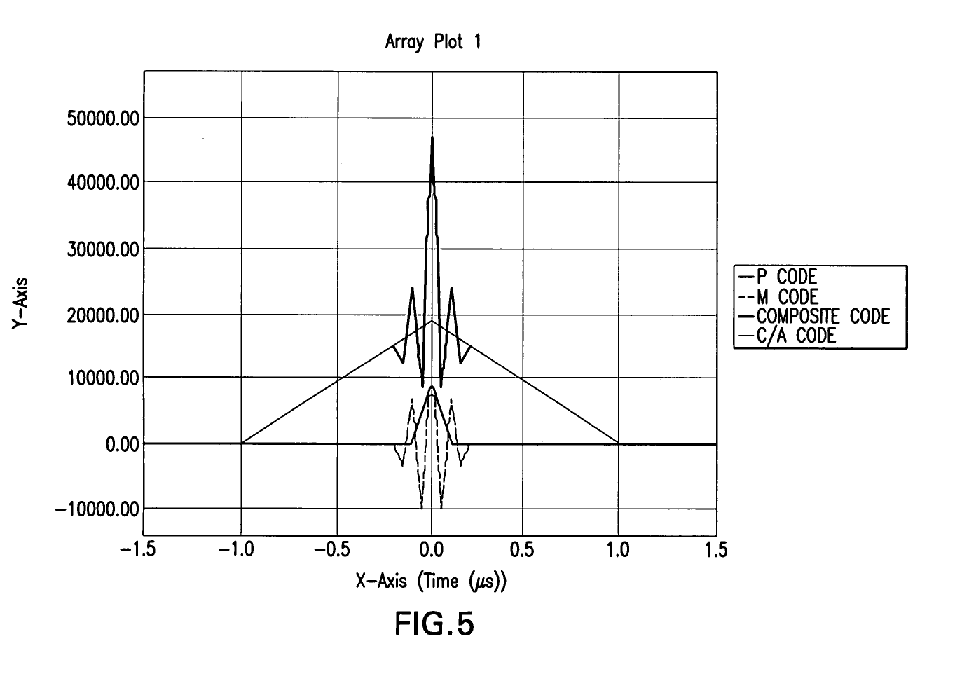

The output of the FFT based correlator is a high-resolution snap-shot of the cross correlation between the incoming signal and locally generated code. The composite autocorrelation function is shown in FIG. 5 along with autocorrelation functions of C/A), P(Y) and M-code.

The high-resolution correlation output is then processed to characterize and remove multipath. The best multipath mitigation algorithm relies on correlation function pattern matching to estimate the multipath environment. This in turn requires large number of correlators for accurate representation of correlation function. The FFT block processing produces an correlation which automatically satisfies this requirement without any additional processing necessary. At the same time, the correlation functions are available from 3 frequencies (L1, L2 and L5) to provide the necessary diversity to estimate the multipath environment with higher fidelity, multipath reflections introduce the delay which is common for all frequencies, however, the phase relationships between reflections are difference for each GPS frequency.

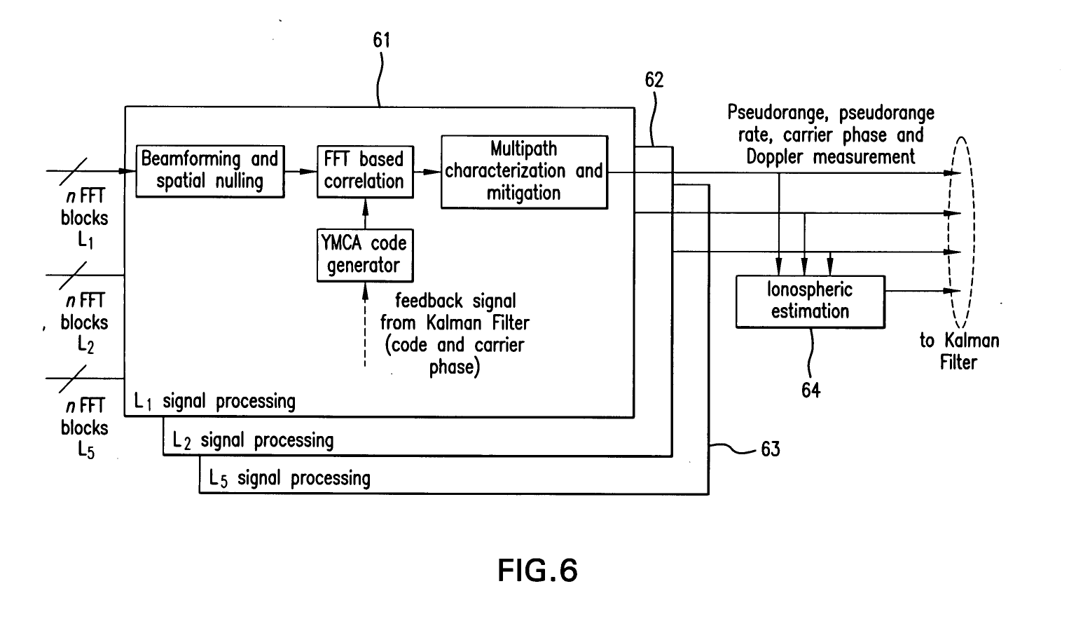

Block diagram of each of the GPS channels 61, 62, 63 is shown in FIG. 6. Channels processing Galileo signal have similar architecture. For case of the GPS channel, three signal frequencies (L1, L2 and L5) are processed in parallel. Beam forming and spatial nulling is performed separately for each signal. Even though the satellite location is common for all three signals, jamming environment may not be.

YMCA code generator creates local replica of the composite code (C/A, P(Y) and M), which is used to correlate with the incoming signal. By using the composite code, the design is simplified compared to the case where each of the codes is processed separately and then coherently combined. Not only there is no need for separate tracking logic that will preserve phase lock necessary for coherent combining but also the total correlation power is increased by taking into account the intermodulation (IM) code which is generated along C/A, P(Y) and M-codes to preserve the constant envelope modulation. For example, if signal levels are 0 dB, −3 dB and −1.2 dB for C/A, P(Y) and M-code respectively, the coherently combined power from the three separate correlators is 3.54 dB higher than that of the C/A code alone. If using a single correlator with the composite signal the output power is 4.21 dB higher than that of the C/A code alone because of the addition of the IM code.

To accommodate decoding of navigation messages that are broadcast from the satellites, the code generator is split into two parts: C/A and P(Y) codes and M and IM codes. This way, two types of navigation message, conventional one that is broadcast on C/A and P(Y) and modernized MNAV that is broadcast on M-code, can be received simultaneously without sacrificing the benefits of the composite code. Next, the message bit is identified for both navigation messages and then stripped from the two signals before they are coherently combined.

M-code processing includes TDDM option that modulates MNAV to every other M-code chip. The chips that do not convey the navigation message can be integrated over the MNAV bit boundaries to improve the signal to noise ratio.

The outputs of all three frequencies are used to estimate the ionospheric delay. All outputs are then passed to the Kalman Filter 45. Kalman Filter 45 uses ultra-tightly coupled architecture, which allows satellites to help each other during tracking and acquisition. For example, if one satellite briefly experiences obscuration and its SNR drops, the tracking loops will use the information from other satellites to maintain the lock by predicting the weak satellite dynamics. This is done through satellite ephemeris processing which provides satellite dynamics estimate that along with the receiver dynamics can be used to estimate the signal dynamics. As a result, the tracking loop bandwidths can be kept extremely low only to track the residual dynamics that is not estimated, for example changes in ionosphere etc. For degraded conditions and anti jamming this is an extremely important feature. Coupled with INS, the GPS tracking can be extended even further to cover cases where the GPS signals are completely jammed during some period.

Galileo or other satellite signals are processed in the similar fashion. Combining GPS, Galileo and other signals (if available) is performed using Kalman Filter. Availability of additional signals besides GPS provides better satellite geometry (lower PDOP) and diversity that improves navigational accuracy.

Coherent Processing Issues

The following is the description of the three types of tracking that we are going to compare. Since we are interested in comparing the SNR performance, the navigation message is assumed known so that all codes can be coherently combined. For the final implementation the issue of the navigation bits which are different for NAV (used with C/A and P(Y) codes) and MNAV (used with M code) will be discussed.

Conventional Tracking

GPS satellites transmit multiple signals on each of two frequencies (L1 and L2). Currently, L1 contains C/A and P(Y) code and in the future there M-code signal will be added. L2 currently contains only P(Y) code but in the future civilian L2C signal will be added along with M-code. Conventional tracking algorithms generally track each of these signals separately and use the measurement from the best one in the navigation process. This means that the total signal power is not combined and that the receiver performance depends on the best SNR achievable from each of the transmitted codes individually, the cross correlation of different codes is negligible so that the main source of disturbance is the thermal noise. The codes with worse performance are tracked even when the code with best performance is tracked, which is the only one used for navigation, in case the best code tracking is lost and the navigation processing has to fall back to using one of the worse codes. In that case, reacquisition of the best code is much faster since it relies on the hand-off from one of the tracked codes.

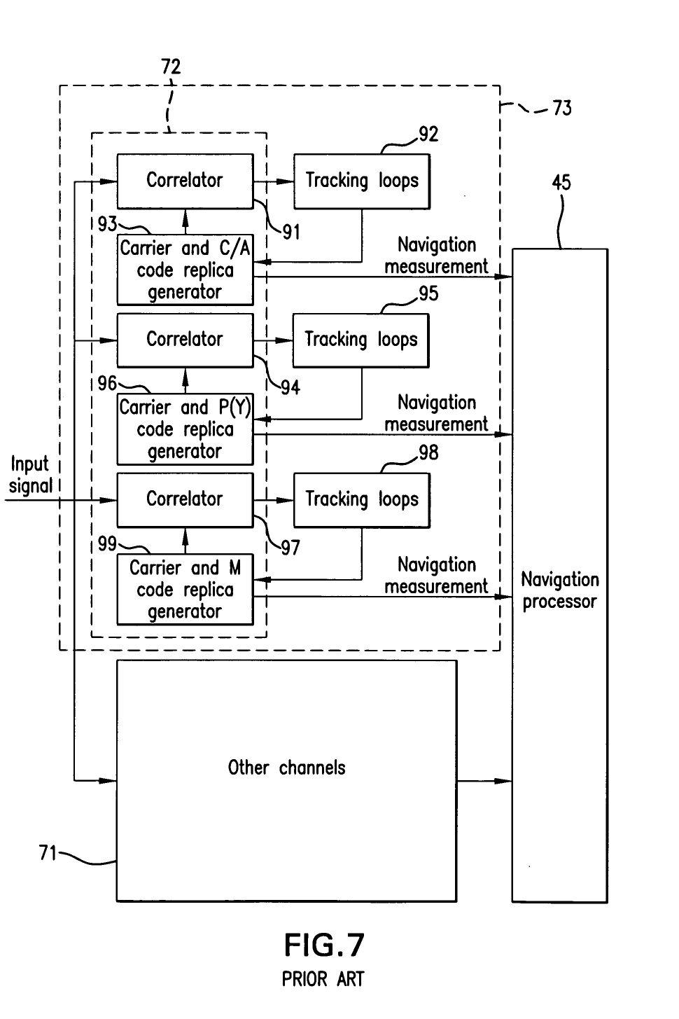

As shown in FIG. 7, the received signal is simultaneously fed to a block processor 42 having multiple correlators 91, 94, 97 (C/A, P and M) in a particular channel of the plurality of channel processors 441, 442, 443, 444, 445, 446, 447 of FIG. 4, for carrier and code tracking. Three different code generators 93, 96, 99 are used at the receiver to generate the code replicas for C/A, P and M codes respectively.

As the name suggests, a correlator performs the task of correlating, or matching, the received signal with the reference signal generated through the local carrier and code replica generators 93, 96, 99. Thus, it measures the similarity between an incoming signal and a reference signal. A conventional correlator works on a sample-by-sample basis and performs correlation in the time domain, while a block correlator performs correlation between the two signals in the frequency domain. This is achieved by performing the conjugate multiplication of the FFTs of the two signals and taking the inverse FFT of the result. The block correlation allows parallel high-resolution correlation structure to be implemented efficiently.

After the initial acquisition of the signal, the tracking loops 92, 95, 98 are used to keep the received signal in lock with the reference signal. The tracking loops consist of phase lock loops (PLLs) and frequency lock loops (FLLs) for tracking the carrier phase, frequency, and delay lock loop (DLL) for tracking the code phase. They help in tracking the continuous changes in code and carrier phase and frequency mainly caused by the Doppler effect. The tracking loops work on the output of the correlator and generate the phase and frequency errors between the received signal and the reference signal.

The carrier and code replica generator acts as a numerically controlled oscillator (NCO) that generates the exact replica of the received signal. The phase and frequency errors from the tracking loops decide the instantaneous code and carrier phase and frequency of the replica generator. The output is fed to the correlator to perform the correlation between the incoming signal and replica signal.

Navigation processor 45, which may be embodied as a navigation filter or Kalman filter as is well-known in the art, works on the output of all channels and helps in determining the position, velocity and time (PVT) of the receiver. The main tasks carried out by the navigation processor are calculating the pseudo-range between the satellites and the receiver, extracting the ephemeris and almanac information from the navigation data and calculating the satellite positions. Using the pseudo-range, satellite positions and exact timing it finally calculates the position and velocity of the receiver.

Coherent Processing Using Composite Code

Since codes transmitted on the same frequency are coherently generated and they experience the same propagation medium, they arrive coherently at the receiver antenna. By using the composite code, the power from each individual code is coherently combined which increases the received signal power while the noise remains the same. This causes increased SNR and better receiver performance. Another benefit of composite code is that this approach requires one correlator as compared with up to 4 correlators, for C/A, P(Y), M-code and IM code which is the inter-modulation product of the first three codes used to maintain the signal with the constant envelope, used in conventional tracking. If one of the codes were jammed, for example C/A-code, the jammed code can be turned off in the composite signal replica generator. However, since the output of the correlator is a combination of correlations from all codes, the code that is jammed cannot be identified.

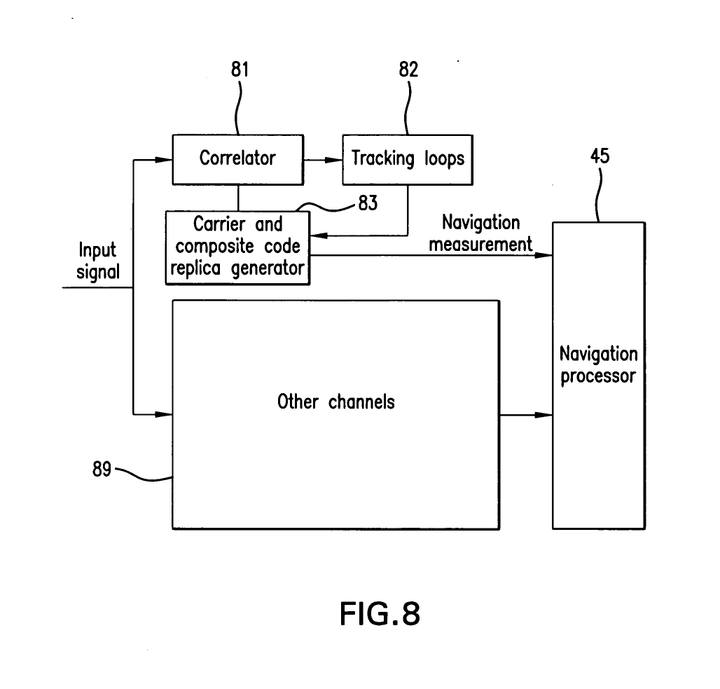

The block diagram for this approach is depicted in FIG. 8. Unlike the conventional tracking receiver, where a different set of correlators, tracking loops and replica generator are used for each code, in coherent processing a single set is used to perform the entire task of tracking three different codes. A single replica generator 83 coherently generates a composite-reference signal having the IM code, M code, P(Y) code or C/A code. The correlator 81 correlates the composite-reference signal with the incoming received signal from a particular global positioning satellite. The received signal has the C/A, P, M and IM codes at the same carrier frequency. Tracking loop 82 helps in maintaining the lock between the received signal and the composite-reference signal. The navigation processor 45 works in the same manner as in the conventional receiver.

Coherent Processing Using Separate Codes

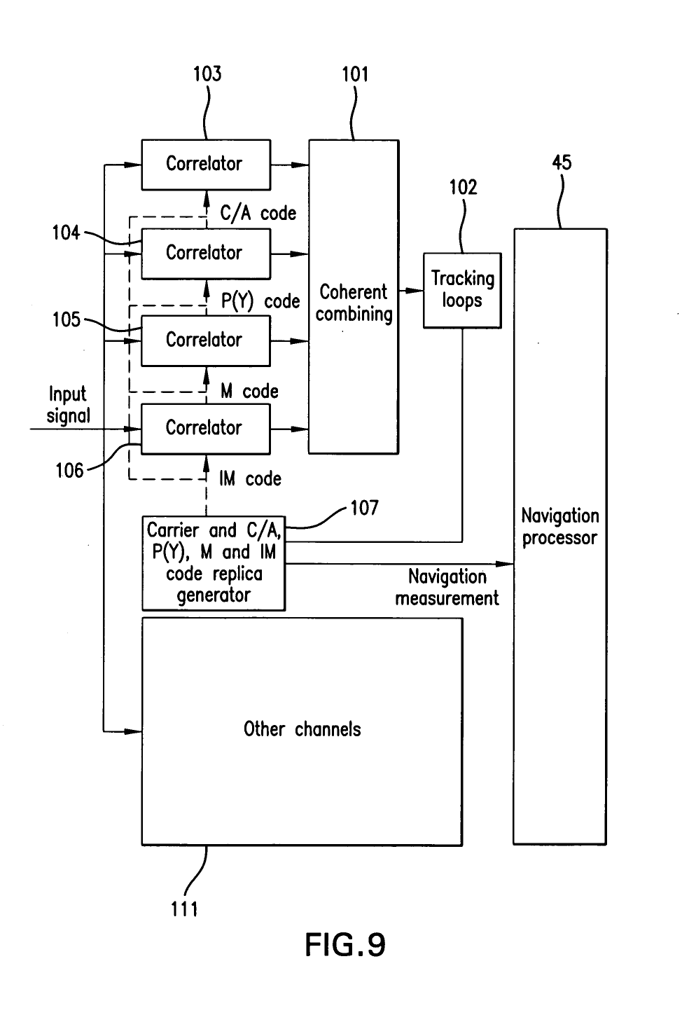

As an alternative to using a single correlator 81 of FIG. 8, multiple correlators 103, 104, 105, 106 of FIG. 9 can process each code separately but the output is then coherently combined or added. The key is the coherent generation of each code replica in the correlator. In this case, the correlations from each of the codes are available for jamming detection so that jammed code can be turned off. If there is no jamming and all codes are on, the final output is identical to the case that uses composite code. The difference from that of FIG. 8, is that in FIG. 9 four correlators have to be used instead of one. In this case, the resources have been traded off for the ability to detect jamming.

FIG. 9 shows the block diagram of this technique. As in the case of conventional receiver, multiple correlators 103, 104, 105, 106 are used to process each code (C/A, P, M and IM) in a particular channel, but a single set of tracking loops 102 and replica generator 107 are used in this case. A single replica generator 107 coherently generates a composite-reference signal that is simultaneously fed to each of the four correlators 103, 104, 105, 106. The outputs of the correlators 103, 104, 105, 106 are coherently combined by coherent combiner 102 before providing the common output to the tracking loops 102. The tracking loops 102 help in tracking the Doppler changes and thus maintaining the lock between the incoming received signal and the composite-reference signal. The navigation processor 45 provides the PVT of the receiver.

Performance Improvement using Coherent Processing

The composite signal includes CA, P, M and IM codes as received by the correlator can be expressed as shown in equation 1.
Input signal=(A_{P1}P_{P}+A_{M1}P_{M}+N₁)cos(ωt)+(−A_{CA1}P_{CA}+A_{IM1}P_{IM}+N_{Q})sin(ωt) (1)
where,
A_{CA1}=Amplitude of CA code
A_{P1}=Amplitude of P code
A_{M1}=Amplitude of M code
A_{IM1}=Amplitude of IM code
P_{CA}, P_{P}, P_{M}, P_{IM} are the respective codes {−1, 1}
N₁, N_{Q} are the white Gaussian noise samples
ω=angular carrier frequency

The composite code replica signal generated at the receiver is given by equation 2.
Replica=(A_{P1}P_{P}+A_{M1}P_{M}+N₁)cos(ωt)+(−A_{CA1}P_{CA}+A_{IM1}P_{IM}+N_{Q})sin(ωt) (2)
where,
A_{CA2}=Amplitude replica of CA code
A_{P2}=Amplitude replica of P code
A_{M2}=Amplitude replica of M code
A_{IM2}=Amplitude replica of IM code

The correlation (multiplication and integration) of the input signal with the replica can be represented as:
Σ(Input signal×replica)=A_{P1}A_{P2} cos² ωt+A_{M1}A_{M2} cos² ωt+A_{P2}N₁ cos² ωt+A_{M1}N₁ cos² ωt+A_{CA1}A_{CA2} sin² ωt+A_{IM1}A_{IM2} sin² ωt−A_{CA2}N_{Q} sin² ωt+A_{IM2}A_{Q} sin² ωt (3)

In the above equation the squares of the similar code signals result in unity, and the cross correlation between the unlike codes is assumed to be zero. The IM code in the composite code signal is a function of CA, P and M codes and is related by the following equations.
A_{IM1}=A_{P1}A_{M1}/A_{CA1} A_{IM2}=A_{P2}A_{M2}/A_{CA2} (4)
After substituting the above equations in equation 3, the mean and variance at the output of the correlator can be found by finding the expected value and the second moment of equation 3.
Mean=A_{CA1}²+A_{P2}²+A_{M2}²+(A_{P2}²A_{M2}²/A_{CA2}²) (5)
A_{P1}A_{M1}A_{P2}A_{M2}
Variance=A_{CA1}A_{CA2}+A_{P1}A_{P2}+A_{M1}A_{M2}+{A_{CA1}A_{CA1}} (6)
where,
σ²=input noise variance
M=number of samples

The carrier to noise density ratio of a coherent processing composite code correlator computed using mean and variance, is expressed as given in equation 7.

$$CNR = \frac{\begin{matrix}{A}_{CA 1} {A}_{CA 2} + {A}_{P 1} {A}_{P 2} + \\ {A}_{M 1} {A}_{M 2} + \{ \frac{ {A}_{P 1} {A}_{M 1} {A}_{P 2} {A}_{M 2}}{{A}_{CA 1} {A}_{CA 1}} \} \times {f}_{s} / 2 {σ}^{2}\end{matrix}}{{A}_{CA 1}^{2} + {A}_{P 2}^{2} + {A}_{M 2}^{2} + ( {A}_{P 2}^{2} {A}_{M 2}^{2} / {A}_{CA 2}^{2} )} \qquad ( 7 )$$

where
fₛ is the sampling rate

The carrier to noise density ratio of a single channel conventional CA code correlator can be found from the above expression by just using the CA code parameters and is shown in equation 8.
CNR_{CA}=A_{CA2} {fₛ/σ² (8)
Using the typical power levels of individual codes: CA code (0 dB), P code (−3 dB) and M code (−1.3 dB) and assuming that the replica codes are also generated at the same power levels, it can be easily found by comparing equations 7 and 8 that a composite code correlator provides about 4.1 dB improvement in the output SNR at the correlator and hence consequently results in improved code and carrier tracking performance of the receiver.

The present invention also includes a receiving method comprising the steps of receiving with an antenna array having a plurality of elements, a plurality of signals, respectively. Fast-Fourier-transform (FFT) correlating the plurality of signals, to a plurality of decorrelated signals, respectively. In response to signal dynamics for each respective tracked satellite, at a plurality of frequencies, the plurality of decorrelated signals are processed to determine a multiplicity of signal estimates for each respective tracked satellite. In response to the multiplicity of estimates for each respective tracked satellite, signal dynamics for each respective tracked satellite.

The receiving method may have the processing step including the steps of determining the multiplicity of signal estimates, with the multiplicity of signal estimates including at least two of pseudo-range estimates, pseudo-range rate estimates, carrier phase estimates, Doppler estimates and correction terms, for each respective tracked satellite; and generating, responsive to the respective at least two of pseudo-range estimates, pseudo-range rate estimates, carrier phase estimates, Doppler estimates and correction terms, for each respective tracked satellite, signal dynamics for each respective tracked satellite.

The receiving method may have the processing step including the steps of generating, responsive to the respective multiplicity of signal estimates for each respective tracked satellite, signal dynamics for each respective tracked satellite, with the signal dynamics including at least two of position, velocity, acceleration, clock error, clock drift, and attitude.

The receiving method may have the processing step including the steps of determining, from the plurality of decorrelated signals, the multiplicity of signal estimates, with the multiplicity of signal estimates including pseudo-range estimates, pseudo-range rate estimates, carrier phase estimates, Doppler estimates and correction terms, for each respective tracked satellite; and generating, responsive to the respective pseudo-range estimates, pseudo-range rate estimates, carrier phase estimates, Doppler estimates and correction terms, for each respective tracked satellite, signal dynamics for each respective tracked satellite, with the signal dynamics including position, velocity, acceleration, clock error, clock drift, and attitude.

The receiving method may further include the step of removing narrowband jammers from the plurality of decorrelated signals. The receiving method as set may have he processing step including the step of processing, with a parallel correlator structure, signal fidelity through high-resolution correlator function, to drive code and carrier tracking errors through correlation pattern matching. The receiving may have the processing step including the step of processing with multipath mitigation algorithms. The receiving method may have he processing step including the step of processing with high-dynamics applications when tracking loop bandwidth must be kept low to prevent excessive noise from corrupting the signal.

The receiving method may have the processing step including the step of processing with anti jamming techniques using spectral excision of narrowband jammers and spatial nulling wideband jammers.

The receiving method may have the processing step including the step of processing with anti jamming techniques using spectral excision of narrowband jammers. The receiving method may have the processing step including the step of processing with anti jamming techniques using spatial nulling wideband jammers. The receiving method may have the processing step including the step of combining, in frequency domain, the plurality of signals from the plurality of antenna elements using wideband beam forming for desired satellites and spatial nulling for jammer suppression.

The receiving method may have the processing step including the step of correcting the pseudo-range estimate and the pseudo-rate estimate for ionospheric and tropospheric delay and satellite clock bias and drift. The receiving method may have the processing step including the step of processing in parallel with a plurality of correlation functions, the respective plurality of signals from a respective satellite.

It will be apparent to those skilled in the art that various modifications can be made to the coherent processing using composite codes system and method, of the instant invention without departing from the scope-or spirit of the invention, and it is intended that the present invention cover modifications and variations of the coherent processing using composite codes system and method provided they come within the scope of the appended claims and their equivalents.

We claim:

1. A coherent processor for use with a plurality of global positioning satellites, each global positioning satellite for transmitting on a plurality of frequencies, a plurality of signals modulated by a plurality of spread-spectrum codes, respectively, comprising:
a replica generator for generating a composite-reference signal having a replica of the plurality of spread-spectrum codes;
a correlator for correlating a received signal from a particular global positioning satellite, with the composite-reference signal; and
a tracking loop for maintaining lock between the received signal and the composite-reference signal.

2. The coherent processor as set forth in claim 1, with the replica generator for generating a composite-reference signal having a replica of the plurality of spread-spectrum codes, with the plurality of spread-spectrum codes including at least one of the IM code, M code, P(Y) code or C/A code.

3. The coherent processor as set forth in claim 1, with the replica generator for generating a composite-reference signal having a replica of the plurality of spread-spectrum codes, with the plurality of spread-spectrum codes including at least two of the IM code, M code, P(Y) code or C/A code.

4. A coherent processor for use with a plurality of global positioning satellites, each global positioning satellite for transmitting on a plurality of frequencies, a plurality of signals modulated by a plurality of spread-spectrum codes, respectively, comprising:
replica-generator means for generating a composite-reference signal having a replica of the plurality of spread-spectrum codes;
correlator means for correlating a received signal from a particular global positioning satellite, with the composite-reference signal; and
tracking-loop means for maintaining lock between the received signal and the composite-reference signal.

5. The coherent processor as set forth in claim 4, with the replica-generator means for generating a composite-reference signal having a replica of the plurality of spread-spectrum codes, with the plurality of spread-spectrum codes including at least one of the IM code, M code, P(Y) code or C/A code.

6. The coherent processor as set forth in claim 4, with the replica-generator means for generating a composite-reference signal having a replica of the plurality of spread-spectrum codes, with the plurality of spread-spectrum codes including at least two of the IM code, M code, P(Y) code or C/A code.

7. A coherent processing method for use with a plurality of global positioning satellites, each global positioning satellite for transmitting on a plurality of frequencies, a plurality of signals modulated by a plurality of spread-spectrum codes, respectively, comprising the steps of:
generating a composite-reference signal having a replica of the plurality of spread-spectrum codes;
correlating a received signal from a particular global positioning satellite, with the composite-reference signal; and
maintaining lock between the received signal and the composite-reference signal.

8. The coherent processing method as set forth in claim 7, with the step of generating a composite-reference signal including the step of generating a composite-reference signal having a replica of the plurality of spread-spectrum codes, with the plurality of spread-spectrum codes including at least one of the IM code, M code, P(Y) code or C/A code.

9. The coherent processing method as set forth in claim 7, with the step for generating a composite-reference signal including the step of a composite-reference signal having a replica of the plurality of spread-spectrum codes, with the plurality of spread-spectrum codes including at least two of the IM code, M code, P(Y) code or C/A code.

10. A coherent processor for use with a plurality of global positioning satellites, each global positioning satellite for transmitting on a plurality of frequencies, a plurality of signals modulated by a plurality of spread-spectrum codes, respectively, comprising:
a replica generator for generating a composite-reference signal having a replica of the plurality of spread-spectrum codes;
a plurality of correlators coupled to the replica generator for correlating a received signal from a particular global positioning satellite, with the plurality of spread-spectrum codes, respectively, of the composite-reference signal, thereby generating a plurality of despread signals, respectively;
a combiner for combining the plurality of despread signals from the plurality of correlators; and
a tracking loop for maintaining lock between the received signal and the composite-reference signal.

11. The coherent processor as set forth in claim 10, with the replica generator for generating a composite-reference signal having a replica of the plurality of spread-spectrum codes, with the plurality of spread-spectrum codes including at least one of the IM code, M code, P(Y) code or C/A code.

12. The coherent processor as set forth in claim 10, with the replica generator for generating a composite-reference signal having a replica of the plurality of spread-spectrum codes, with the plurality of spread-spectrum codes including at least two of the IM code, M code, P(Y) code or C/A code.

13. A coherent processor for use with a plurality of global positioning satellites, each global positioning satellite for transmitting on a plurality of frequencies, a plurality of signals modulated by a plurality of spread-spectrum codes, respectively, comprising:
replica-generator means for generating a composite-reference signal having a replica of the plurality of spread-spectrum codes;
a plurality of correlator means coupled to the replica-generator means for correlating a received signal from a particular global positioning satellite, with the plurality of spread-spectrum codes, respectively, of the composite-reference signal, thereby generating a plurality of despread signals, respectively;
combiner means, coupled to the plurality of corrleator means, for combining the plurality of despread signals from the plurality of correlators; and
tracking-loop means for maintaining lock between the received signal and the composite-reference signal.

14. The coherent processor as set forth in claim 13, with the replica generator for generating a composite-reference signal having a replica of the plurality of spread-spectrum codes, with the plurality of spread-spectrum codes including at least one of the IM code, M code, P(Y) code or C/A code.

15. The coherent processor as set forth in claim 13, with the replica generator for generating a composite-reference signal having a replica of the plurality of spread-spectrum codes, with the plurality of spread-spectrum codes including at least two of the IM code, M code, P(Y) code or C/A code.

16. A coherent processing method for use with a plurality of global positioning satellites, each global positioning satellite for transmitting on a plurality of frequencies, a plurality of signals modulated by a plurality of spread-spectrum codes, respectively, comprising the steps of:
generating a composite-reference signal having a replica of the plurality of spread-spectrum codes;
correlating a received signal from a particular global positioning satellite, with the plurality of spread-spectrum codes, respectively, of the composite-reference signal, thereby generating a plurality of despread signals, respectively;
combining the plurality of despread signals from the plurality of correlators; and
maintaining lock between the received signal and the composite-reference signal.

17. The coherent processing method as set forth in claim 16, with the step of generating a composite-reference signal including the step of generating a composite-reference signal having a replica of the plurality of spread-spectrum codes, with the plurality of spread-spectrum codes including at least one of the IM code, M code, P(Y) code or C/A code.

18. The coherent processing method as set forth in claim 16, with the step for generating a composite-reference signal including the step of a composite-reference signal having a replica of the plurality of spread-spectrum codes, with the plurality of spread-spectrum codes including at least two of the IM code, M code, P(Y) code or C/A code.
